(19) United States
(12) Patent Application Publication
(10) Pub. No.: US 2010/0287180 A1
(43) Pub. Date: Nov. 11, 2010

(54) Apparatus and Method for Issuing Certificate with User's Consent

(75) Inventors: Seung-Hyun Kim, Daegu (KR); Dae-Seon Choi, Daejeon (KR); Jong-Hyouk Noh, Daejeon (KR); Sang-Rae Cho, Daejeon (KR); Yeong-Sub Cho, Daejeon (KR); Seung-Hun Jin, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, DAEJEON-CITY (KR)

(21) Appl. No.: 12/280,230

(22) PCT Filed: Dec. 8, 2006
(86) PCT No.: PCT/KR06/05319

§ 371 Date: Aug. 21, 2008

(30) Foreign Application Priority Data
Feb. 21, 2006 (KR) 10-2006-0016666

(51) Int. Cl. G06F 17/30

(52) U.S. Cl. 707/769; 707/E17.014

(57) ABSTRACT

Provided is an apparatus and method for issuing a certificate by receiving in real-time a user's consent in an online or offline environment. The apparatus includes: a database unit storing and managing a list of certificates requiring a user's consent and personal information containing the identity and a contact point of the user of the certificates; a determiner, when issuance of a certificate is requested, receiving identity information of an applicant and determining whether the certificate requested by the applicant is listed in the certificate list stored in the database unit; and a consent inquiry unit, when the requested certificate is listed in the certificate list, transmitting the identity information of the applicant and the name of the certificate to a contact point of the user of the certificate, which is stored in the database unit, and inquiring whether the user consents to the certificate issuance.

### TECHNICAL FIELD

This application claims the benefit of Korean Patent Application No. 10-2006-0016666, filed on Feb. 21, 2006, in the Korean Intellectual Property Office, the disclosure of which is incorporated herein in its entirety by reference.

The present invention relates to an apparatus and method for issuing a certificate by receiving in real time a user's consent in an online or offline environment.

### BACKGROUND ART

A process of issuing a certificate can be commonly performed using two methods.

In the first method for an offline environment, an individual visits a certificate issuing authority, and after showing his/her identity the individual obtains a certificate containing personal information. In this case, the individual may sign a power of attorney and authorize a third person to obtain the certificate containing personal information.

In the second method for an online environment, an individual obtains a certificate by accessing the homepage of a certificate issuing authority. That is, the individual undergoes an appropriate identity authentication process (digital certificate and/or ID/password authentication), selects a desired certificate, and obtains the desired certificate.

### DISCLOSURE OF INVENTION

Technical Problem

However, the conventional certificate issuing process has the following problems. For example, in the process of issuing a certificate in the offline environment, the identity documents of an individual requiring a certificate may be duplicated or falsified by another person, who can thus illegally acquire the certificate.

In the online environment, a third party may obtain identity authentication (digital certificate and/or ID/password authentication) information of a user requiring a certificate, and thus illegally acquire the certificate.

Such certificates illegally acquired on another person's name might then be used in various transactions, such as real estate and stock operations, where a blind process of confirming the identity of a person is employed. Furthermore, since a certain person does not know that a certificate on his/her name was illegally issued and becomes aware of this only after a crime was successfully accomplished, the person might suffer serious financial damages.

Several conventional methods for addressing these problems are used in the offline and online environments. In one of these methods, in the offline environment, the identity of an applicant applying through a proxy for a certificate is confirmed by using a call-ID authentication method for a mobile terminal. However, in the online environment, even though such a method is used, another person may still abuse the certificate issuance process, and illegally obtain the certificate.

In another method in the online environment, a certificate issuing authority performs an identity authentication process by receiving from a user a pre-set password when the user requests a certificate via a certificate issuing apparatus. However, in this method, a user must directly use a certificate issuing apparatus or a personal terminal and input a password. In addition, a third party might still illegally acquire the pre-set password and obtain and use a certificate on the user's name without his/her knowledge.

### Technical Solution

The present invention provides an apparatus and method for issuing a certificate by receiving in real time a user's consent in an online or offline environment.

### Advantageous Effects

According to the present invention, by directly obtaining a user's consent for issuing a certificate of the user in an online or offline environment, illegal certificate issuance can be prevented.

By determining in realtime by obtaining the user's consent through a user terminal whether the certificate is issued, a user-friendly service can be provided. In addition, in the side of the user of the certificate, the user can directly take part in a certificate issuing process in realtime.

### DESCRIPTION OF DRAWINGS

The above and other features and advantages of the present invention will become more apparent by describing in detail exemplary embodiments thereof with reference to the attached drawings in which:

FIG. 1 is a block diagram of a certificate issuing apparatus according to an embodiment of the present invention;

FIG. 2 is a signaling diagram of a process of issuing a certificate with a user/s consent, the process being performed among a user, a management center, and an issuing authority according to an embodiment of the present invention;

FIG. 3 is a flowchart illustrating a method of issuing a certificate with a user's consent according to an embodiment of the present invention;

FIG. 4 illustrates a consent request message transmitted to a user according to an embodiment of the present invention; and

FIG. 5 is a schematic block diagram of a system using a process of issuing a certificate with a user's consent according to an embodiment of the present invention.

### BEST MODE

According to an aspect of the present invention, there is provided a certificate issuing apparatus comprising: a database unit registering and managing a list of certificates requiring a user's consent and personal information containing the identity and a contact point of the user of the certificates; a determiner, when issuance of a certificate is requested, receiving identity information of an applicant and determining whether the certificate requested by the applicant is listed in the certificate list stored in the database unit; and a consent inquiry unit, when the requested certificate is listed in the certificate list, transmitting the identity information of the applicant and the name of the certificate to a contact point of the user of the certificate, which is stored in the database unit, and inquiring whether the user consents to the certificate issuance.

The certificate issuing apparatus may further comprise a certificate issuing unit receiving a response to the inquiry from the user of the certificate and determining whether the certificate is issued based on the response.

According to another aspect of the present invention, there is provided a certificate issuing method comprising: storing and managing a list of certificates requiring a user's consent and personal information containing identity information of the user of the certificates and a contact point; (b) when issuance of a certificate is requested, receiving identity information of an applicant and determining whether the name of the certificate requested by the applicant matches a name stored in operation (a); and (c) if the certificate names match each other in operation (b), transmitting the identity information of the applicant and the name of the certificate to a contact point of the user of the certificate, which is stored in operation (a), and inquiring the user whether the user consents to the certificate issuance.

### Mode for Invention

Preferred embodiments of the present invention will be described below with reference to the accompanying drawings. In the drawings, the same or similar elements are denoted by the same reference numerals. In the following description, well-known functions or constructions are not described in detail.

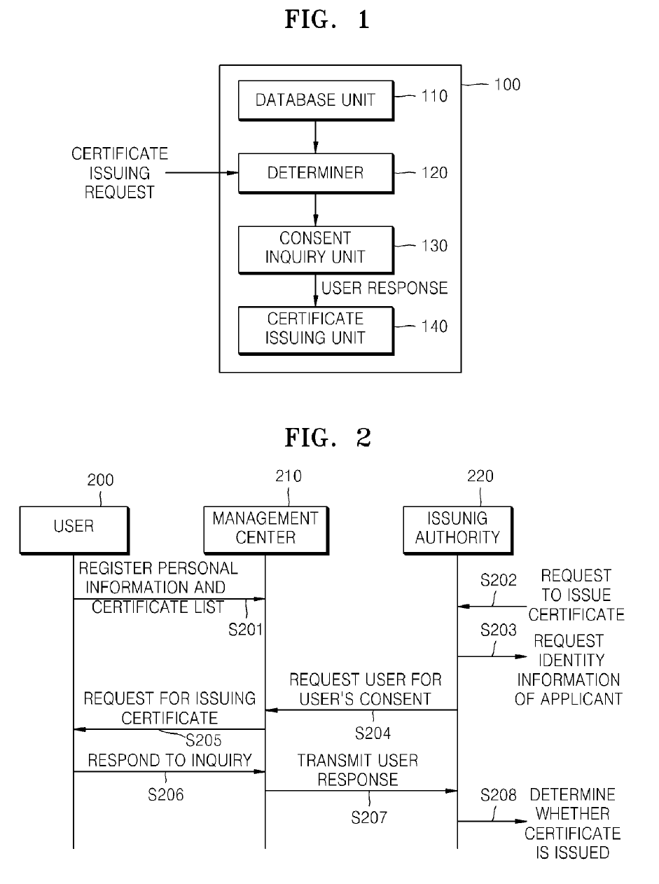

FIG. 1 is a block diagram of a certificate issuing apparatus 100 according to an embodiment of the present invention.

Referring to FIG. 1, the certificate issuing apparatus 100 includes a database unit 110, a determiner 120, a consent inquiry unit 130, and a certificate issuing unit 140.

The database unit 110 stores and manages a list of certificates requiring a user's consent and personal information of the user containing identity information and a contact point. The user can subscribe for a user consent service using one of various routes such as the Internet, a mobile communication terminal, and a direct visit. In this case, several pieces of user information are required. That is, when the user subscribes for the user consent service, the user fills in an application form for confirming his/her identity, a contact point to receive the user consent service, and a list of certificates which he/she wants to manage. The contact point may include a land telephone number, a mobile phone number, an Internet messenger ID, an address, etc. The certificate list may include all types of documents of interest to a user.

When issuance of a certificate is requested, the determiner 120 receives identity information of an applicant and determines whether the certificate requested by the applicant is listed in the certificate list registered in the database unit 110.

That is, the determiner 120 confirms the identity of the applicant by receiving the identity information (e.g., a social security number) from the applicant. After the identity of the applicant is confirmed, the determiner 120 and determines whether the certificate requested by the applicant is listed in the certificate list stored in the database unit 110.

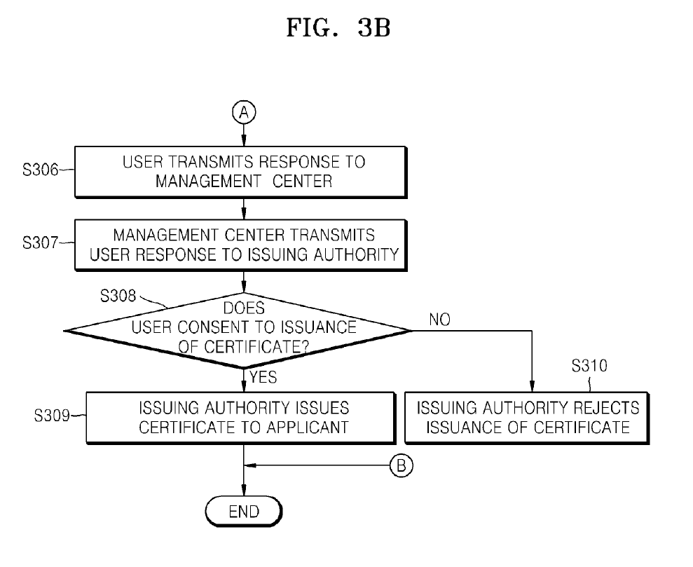

If the certificate requested by the applicant is on the list of certificate in the database unit 110, the consent inquiry unit 130 transmits the identity information of the applicant, which is received from the determiner 120, and the name of the certificate to a contact point of the owner of the certificate, which is registered in the database unit 110, and inquires the owner of the certificate who has subscribed for the user consent service for whether he/she consents that the certificate is issued to the applicant. An embodiment related to this will be described with reference to FIG. 3 later.

The certificate issuing unit 140 receives a response to the inquiry to the owner of the certificate from the consent inquiry unit 130 and determines whether the certificate is issued based on the response of the user (the owner of the certificate who has subscribed for the user consent service). That is, when the user's consent is received, the certificate issuing unit 140 issues the certificate to the applicant, and if not, the certificate issuing unit 140 rejects the issuance of the certificate.

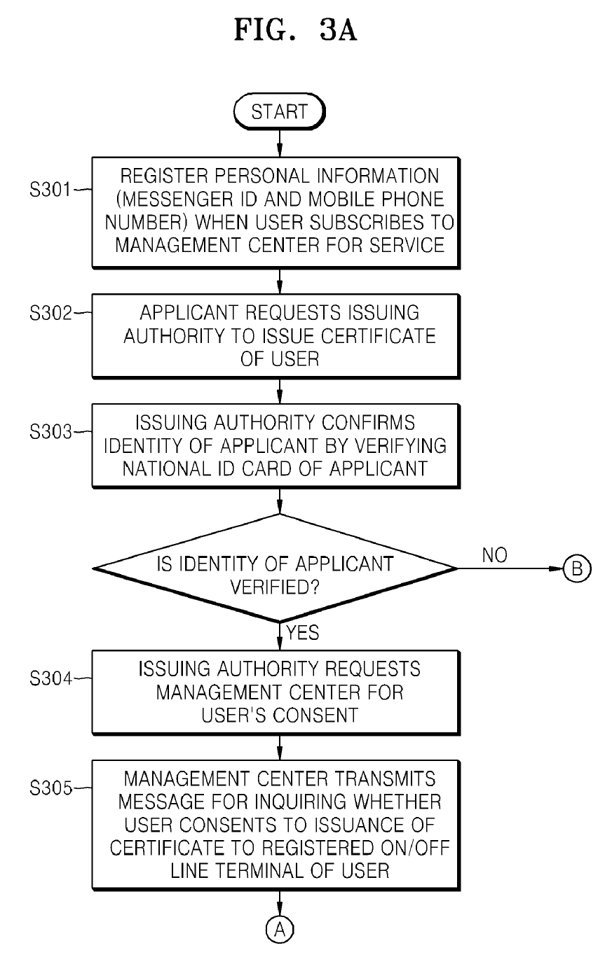

FIG. 2 is a signaling diagram of a process of issuing a certificate with a user's consent, the process being performed among a user 200, a management center 210, and an issuing authority 220, according to an embodiment of the present invention. FIG. 3 is a flowchart illustrating a method of issuing a certificate with a user's consent according to an embodiment of the present invention.

In operations S201 and S301, the user 200 subscribes to the management center 210 for the user consent service. When an applicant requests a certificate online or offline from the issuing authority 220 in operations S202 and S302, the issuing authority 220 confirms the identity of the applicant in operations S203 and S303. That is, a process of directly confirming a national ID card of the applicant is performed to confirm the identity of the applicant in an offline environment, and an equivalent process is performed in an online environment.

Before issuing the certificate, the issuing authority 220 requests the management center 210 to determine whether the user 200 consents to the issuance of the certificate in operations S204 and S304. To do this, the issuing authority 220 transmits a message including information, such as identity information (name and photograph) of the applicant, a purpose, and the name of the certificate, to the management center 210. Since a signature or encryption security mechanism is applied to the message, the management center 210 extracts an original message by performing a verification process. The management center 210 determines whether a certificate which the user 200 has registered when the user 200 subscribed for the user consent service matches the certificate requested by the issuing authority 220, and if the certificate which the user 200 has registered matches the certificate requested by the issuing authority 220, the management center 210 proceeds to a next procedure.

In operations S205 and S305, the management center 210 transmits a consent request message to the user 200. In this case, various terminal services, such as the Internet, telecommunication, and mobile communication, can be used according to a user's access state and a user's preference. The user 200 receives the consent request message using a currently used terminal service, and since the signature or encryption security mechanism is applied to the consent request message, the original consent request message is extracted by performing a verification process.

In operations S206 and S306, the user 200 confirms the consent request message and transmits a consent or reject message to the management center 210. Then, in operations S207 and S307, the management center 210 transmits the consent or reject message to the issuing authority 220. In operations S208 and S308 through S310, the issuing authority 220 issues the certificate if the user 200 consents to the issuance of the certificate or rejects the issuance of the certificate if the user 200 rejects the issuance of the certificate.

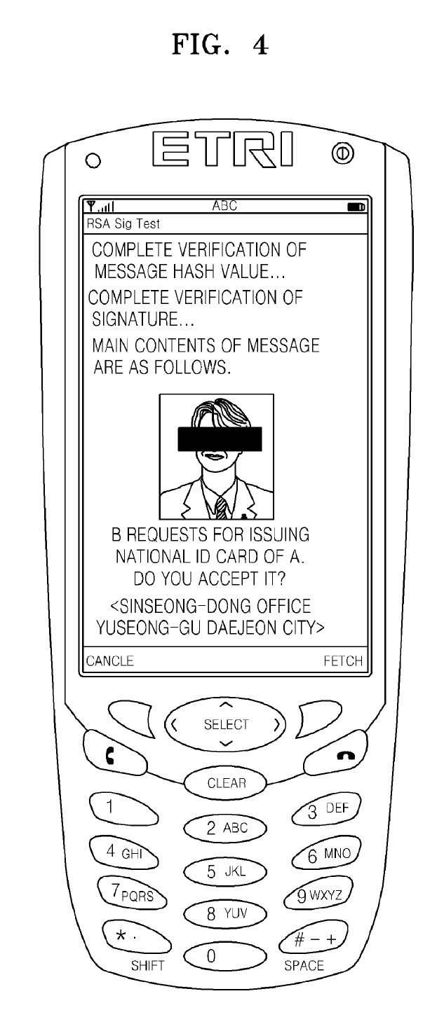

FIG. 4 illustrates a consent request message transmitted to a user according to an embodiment of the present invention.

When an applicant wants to obtain one of certificates registered by the user who has subscribed for the user consent service, the user receives a message for confirming whether the user consents to the issuance of the certificate as illustrated in FIG. 4.

That is, according to the received message, identity (name and photograph) of the applicant, a requested certificate type, and a name of an issuing authority (e.g., a village office) requesting the user for a response are displayed. However, the illustration of FIG. 4 is only an embodiment of the present invention, and the present invention is not limited to this.

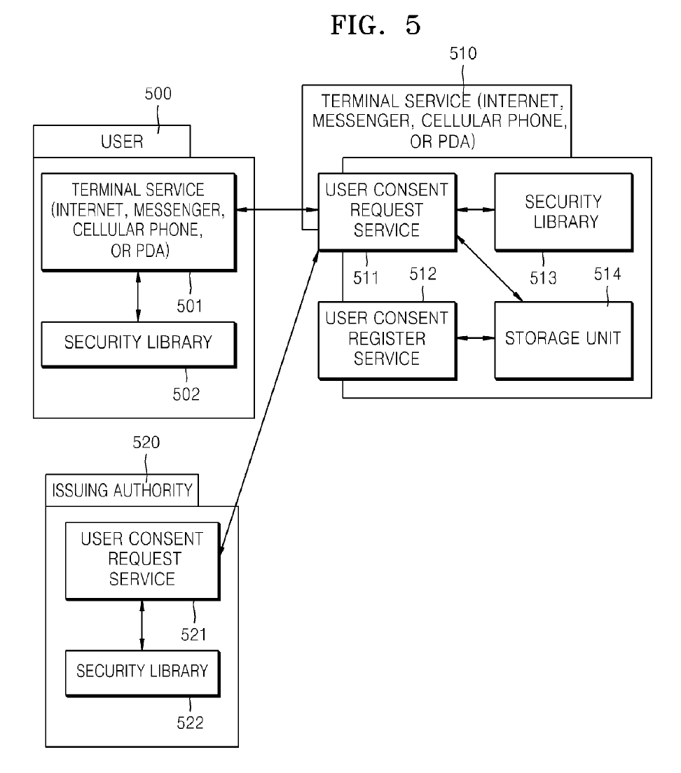

FIG. 5 is a schematic block diagram of a system required for a process of issuing a certificate with a user's consent according to an embodiment of the present invention.

Referring to FIG. 5, the system includes a user 500, a management center 510, and an issuing authority 520. The user 500 uses a terminal service 501, such as the Internet, wired/wireless telecommunication, or a similar one, and a security library 502 for communication security kept with the management center 510.

An example of the terminal service 501 of the user 500 is an Internet messenger (IM), and in another environment, a mobile communication terminal, such as a cellular phone or a Personal Digital Assistant (PDA), can correspond to the terminal service 501.

The terminal service 501 receives a user consent request message from the management center 510 and transmits a response message according to the selection of the user 500 to the management center 510. Various security techniques can be applied to the messages to guarantee reliability of communication between the terminal service 501 and the management center 510, and in the current embodiment, high-level security is provided using the security library 502.

The management center 510 includes a user consent register service 512, a user consent request service 511, a security library 513, and a storage unit 514.

The management center 510 is a system taking charge of the user consent service, allows the user 500 to subscribe for the user consent service using the user consent register service 512, and responds a result by exchanging messages with the user 500 using the user consent request service 511.

The user consent register service 512 operates according to a request of the user 500, and the user 500 can subscribe for the user consent service using various routes, such as the Internet, a mobile communication terminal, and a direct visit. When the user 500 subscribes for the user consent service, the user 500 must fill in an application form for confirming the identity of the user 500, an ID of the terminal service 501 of the user 500, a contact point such as a location or address, and certificates which the user 500 wants to manage, and the application form is stored in the storage unit 514 of the management center 510.

The issuing authority 520 is in charge of a job for issuing a certificate and can issue the certificate in the online or offline environment. The user 500 or an applicant can request the issuing authority 520 to issue a certificate of the user 500, and in this case, if a user consent request service 521 is installed in the issuing authority 520 according to a mutual agreement between the management center 510 and the issuing authority 520, the issuing authority 520 operates the user consent request service 521.

The issuing authority 520 includes the user consent request service 521 and a security library 522. The user consent request service 521 processes user consent information requested by the issuing authority 520. The user consent request service 521 downloads the identity of the user 500, certificates managed by the user 500, and contact information of the terminal service 501 from the storage unit 514 of the management center 510.

The issuing authority 520 verifies the applicant and a certificate requested by the applicant, if the certificate requested by the applicant is one of the certificates managed by the user 500, the issuing authority 520 transmits a user consent request message to the terminal service 501 of the user 500 and receives a response to the user consent request message from the terminal service 501 of the user 500.

The security library 522 provides various security mechanisms for providing reliable communication between the user consent request service 511 of the management center 510 and the terminal service 501 of the user 500.

The issuing authority 520 transmits identity information (name and photograph) of the applicant, a purpose, and the name of the certificate to the management center 510, and then the management center 510 transmits and receives messages to and from the terminal service 501 of the user 500 and transmits a result message to the issuing authority 520. If the user 500 consents to the issuance of the certificate, the issuing authority 520 issues the certificate to the applicant, and if the user 500 does not consent to the issuance of the certificate, the issuing authority 520 rejects the issuance of the certificate.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A certificate issuing apparatus comprising:
a database unit registering and managing a list of certificates requiring a user's consent and personal information containing the identity and a contact point of the user of the certificates;
a determiner, when issuance of a certificate is requested, receiving identity information of an applicant and determining whether the certificate requested by the applicant is listed in the certificate list stored in the database unit; and
a consent inquiry unit, when the requested certificate is listed in the certificate list, transmitting the identity information of the applicant and the name of the certificate to a contact point of the user of the certificate, which is stored in the database unit, and inquiring whether the user consents to the certificate issuance.

2. The certificate issuing apparatus of claim 1, further comprising a certificate issuing unit receiving a response to the inquiry from the user of the certificate and determining whether the certificate is issued based on the response.

3. The certificate issuing apparatus of claim 1, wherein the contact point comprises a terminal service registered in an online messenger application.

4. A certificate issuing method comprising:
(a) storing and managing a list of certificates requiring a user's consent and personal information containing identity information of the user of the certificates and a contact point;
(b) when issuance of a certificate is requested, receiving identity information of an applicant and determining whether the name of the certificate requested by the applicant matches a name stored in operation (a); and
(c) if the certificate names match each other in operation (b), transmitting the identity information of the applicant and the name of the certificate to a contact point of the user of the certificate, which is stored in operation (a), and inquiring the user whether the user consents to the certificate issuance.

5. The certificate issuing method of claim 4, further comprising (d) receiving a response to the inquiry from the user of the certificate and determining whether the certificate is issued based on the response.
